(19) United States
(12) Patent Application Publication
(10) Pub. No.: US 2018/0122115 A1
(43) Pub. Date: May 3, 2018

(54) SELF IMAGING SCREEN

(71) Applicant: Darnell Harrison, Lake Havasu City, AZ (US)

(72) Inventor: Darnell Harrison, Lake Havasu City, AZ (US)

(21) Appl. No.: 15/335,527

(22) Filed: Oct. 27, 2016

(51) Int. Cl. G06T 11/60; G09B 5/02

(52) U.S. Cl. CPC G06T 11/60; G09B 5/02

(57) ABSTRACT

An imaging station that includes: an imaging screen adapted to be integrated with an image of a user; a base, wherein the base supports the imaging screen; a camera, where the camera captures an image of the user and said image is manipulated for display on the imaging screen; and a means to integrate a pre-selected uniform onto the user image for display on the imaging screen. The imaging station may further including a media player.

### BACKGROUND OF THE INVENTION

### Field of Invention

The present invention relates to a self-imaging screen that converts images as desired by the user.

### Description of Related Art

Self-imaging is important to achieving various goals. In order for individuals to reach certain plateaus in life there must be some forward thinking as to their anticipated goals and self-imaging is an important aspect thereof. This aspect is particularly helpful with youth who may be contemplating various careers for their life. As an aid to this particular career planning it is important to envision one's self in various careers and visualizing a position in a particular career or profession. It would therefore be advantageous to actually engage into imaging of a particular career by dressing as a particular professional such as a doctor, policeman, fireman, nurse or otherwise. Many professions have uniforms that are associated with them and thus an individual could take advantage of self-imaging in the profession's uniform or garment.

### SUMMARY OF THE INVENTION

The present invention relates to an imaging station that includes: an imaging screen adapted to be integrated with an image of a user; a base, wherein the base supports the imaging screen; a camera, where the camera captures an image of the user and said image is manipulated for display on the imaging screen; and a means to integrate a pre-selected uniform onto the user image for display on the imaging screen. The imaging station may further including a media player.

### BRIEF DESCRIPTION OF DRAWINGS

FIG. 1 depicts a self-imaging screen in accordance with the present invention.

### DETAILED DESCRIPTION

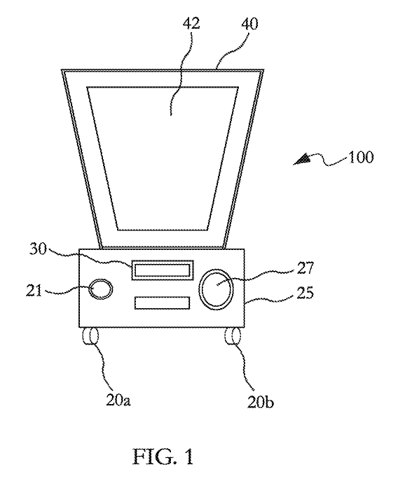

The present invention relates to a self-imaging screen and formatting device. This self-imaging screen enables individuals to incorporate an image of themselves into a particular professional uniform and thus physically visualize themselves in a uniform. A self-imaging screen according to the present invention is depicted in FIG. 1. Self-imaging station 100 includes an imaging screen 42 surrounded by a frame of 40. The screen 42 and frame 40 are mounted on a base 25. The base 25 preferably includes all control functions and electronics associated with the imaging capabilities of the imaging screen 42. The base 25 may be mounted on wheels 20a, 20b as shown in FIG. 1.

Other features of the self-imaging screen 42 may include a speaker 21 for audio capabilities along with a sub-woofer 27. A media player 30 provides an insertion point for media such as CDs, MP3 players or otherwise. Further imaging software is associated with the imaging screen 42 that enables the user to take a photograph of themselves and then project this image onto the screen 42. Through this photograph the imaging may be manipulated to place suitable professional uniform onto the user's image for display. Therefore, a user can easily have a clear depiction of themselves in a particular profession. Further the imaging may be modified for depiction of multiple professions.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An imaging station comprising:
an imaging screen adapted to be integrated with an image of a user;
a base, wherein the base supports the imaging screen;
a camera, where the camera captures an image of the user and said image is manipulated for display on the imaging screen; and
a means to integrate a pre-selected uniform onto the user image for display on the imaging screen.

2. The imaging station according to claim 1, further including a media player.

3. The imaging station according to claim 2, where the media player is a CD or a MP3 player.

4. The imaging station according to claim 2, further including a speaker.

5. The imaging station according to claim 2, further including a sub-woofer.

6. The imaging station according to claim 1, further including a set of wheels.
